(19) United States
(12) Patent Application Publication
(10) Pub. No.: US 2026/0188333 A1
(43) Pub. Date: Jul. 2, 2026

(54) AUDIO PROCESSING USING AUDITORY ANALYSIS

(71) Applicant: HARMAN BECKER AUTOMOTIVE SYSTEMS, INC., Novi, MI (US)

(72) Inventors: Shailesh SAKRI, Bangalore (IN); Keerthi Sagar HINDUPUR, Bangalore (IN); Adithya HH, Hassan (IN)

(21) Appl. No.: 19/210,787

(22) Filed: May 16, 2025

Related U.S. Application Data
(60) Provisional application No. 63/739,442, filed on Dec. 27, 2024.

(51) Int. Cl. G10L 19/02

(52) U.S. Cl. CPC G10L 19/0204

(57) ABSTRACT

Techniques for techniques for audio processing using auditory analysis are described. In some embodiments, the techniques include generating auditory bands based on an audio input, performing frequency domain processing on the auditory bands to generate processed auditory bands, and producing an audio output by reconstructing the processed auditory bands, where the where the auditory bands and the processed audio bands include exponentially spaced center frequencies.

### CROSS-REFERENCE TO RELATED APPLICATIONS

This application claims the benefit of U.S. Provisional patent application titled, “AUDIO PROCESSING USING AUDITORY ANALYSIS,” filed on Dec. 27, 2024, and having Ser. No. 63/739,442. The subject matter of this related application is hereby incorporated herein by reference.

### BACKGROUND

### Field of the Various Embodiments

This application relates to techniques for audio processing, and more specifically, to audio processing using auditory analysis.

### Description of the Related Art

Audio systems utilize wide varieties of techniques to achieve post processing effects for the end user experience. The effects can include removing undesired content, loss compensation, mixing different signals, adding effects to create an audio atmosphere, and so on. Some effects are accomplished using linear filters and transform domain techniques. Many transform domains are available for processing audio signals. Transform domain transformers decompose the audio signal for better handling of analysis of the signal. One example includes discrete Fourier transforms for frequency domain processing.

Typical frequency domain processing, for example, using discrete Fourier transforms, converts discrete and equally spaced time domain audio signal into discrete and equally spaced frequency domain samples. The frequency domain representation is of fixed resolution or spacing across all frequencies. That is, each discrete frequency band has the same bandwidth. The frequency domain samples are processed in the frequency domain to apply a desired effect and an inverse transform is applied to convert the processed frequency domain samples back into time domain samples. While uniform bandwidth transforms enable a simple and consistent transform technique, uniform bandwidth transforms can cause a number of problems for audio signal analysis. For example, in the auditory system higher resolution is often required for lower frequency audio components.

As a result, one drawback of using typical frequency domain processing is that to achieve higher resolution for lower frequencies, the Fourier transforms need to be computed with a very large number of frequency bands across the entire frequency spectrum, low and high alike. Processing computations, memory requirements, and latencies grow linearly with the number of frequency bins, while user experience benefits are limited to a relatively small number of the frequency bins. Typical frequency domain processing requires excessive resource requirements including high levels of compute, memory, and storage usage for a benefit that provides a practical benefit that is limited to low frequencies. Resource usage is even higher for signals of higher sampling rate in the time domain.

As the foregoing illustrates, what is needed in the art is improved techniques for audio processing.

### SUMMARY

One embodiment of the present disclosure sets forth a method that includes separating an audio input into exponentially spaced auditory bands comprising exponentially spaced center frequencies, performing frequency domain processing on the exponentially spaced auditory bands to generate processed auditory bands, and reconstructing the processed auditory bands to generate an audio output and produce a sound field. Further embodiments include systems and non-transitory computer-readable media that perform the steps of the method.

At least one technical advantage of the disclosed techniques relative to the prior art is that the disclosed techniques provide greater efficiency in processing audio signals while retaining human-discernable audio quality. The disclosed techniques reduce hardware resource usage including compute, memory, and storage relative to prior approaches. The disclosed techniques are capable of increasing audio quality relative to prior approaches, for example, when using similar hardware resource usage as prior approaches. In some cases, the disclosed techniques enable both greater efficiency in processing audio signals and increased human-discernable audio quality. The disclosed techniques provide further advantage for signals with higher sampling frequencies. The added compute, memory, and storage is lesser than other techniques, as there are only a few wide bands added towards the higher frequency end of the spectrum, maintaining the same resolution for lower frequency, thereby maintaining discernable audio quality. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating a computing system according to various embodiments;

FIG. 2 is a diagram illustrating the audio processing application of FIG. 1, according to various embodiments;

FIG. 3 is a diagram illustrating a magnitude response graph with twenty auditory bands, according to various embodiments;

FIG. 4 is a diagram illustrating a magnitude response graph with fifty auditory bands, according to various embodiments; and

FIG. 5 is a flow diagram of method steps for generating a sound field using an auditory band processing application, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

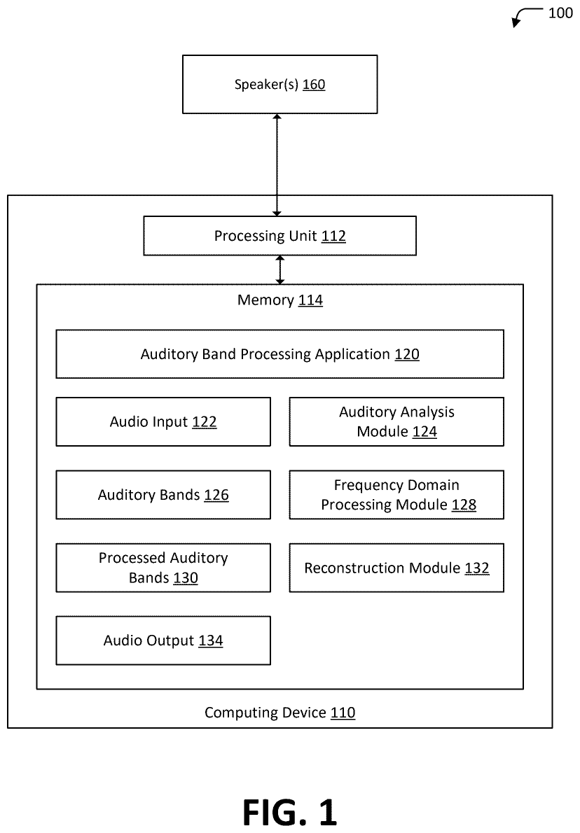

FIG. 1 is a schematic diagram illustrating a computing system 100 according to various embodiments. As shown, the computing system 100 includes, without limitation, one or more computing devices 110 and one or more speakers 160. A computing device 110 includes, without limitation, one or more processing units 112 and one or more memories 114. In various embodiments, an interconnect bus (not shown) connects the one or more processing units 112, the one or more memories 114, the speakers 160, and any other components of the computing device 110. The one or more memories 114 store, without limitation, an auditory band processing application 120, one or more audio inputs 122, one or more auditory analysis modules 124, auditory bands 126, one or more frequency domain processing modules 128, processed auditory bands 130, one or more reconstruction modules 132, and one or more audio outputs 134. While shown separately from the auditory band processing application 120, auditory analysis modules 124, frequency domain processing modules 128, and reconstruction modules 132, can include executable instructions that work in concert with the auditory band processing application 120 as submodules and/or separate software modules.

In various embodiments, the one or more computing devices 110 are included in an audio system such as an audio system found in a vehicle system, a home theater system, a soundbar and/or the like. In some embodiments, one or more computing devices 110 are included in one or more devices, such as consumer products (e.g., portable speakers, gaming, etc. products), vehicles (e.g., the head unit of an automobile, truck, van, etc.), smart home devices (e.g., smart lighting systems, security systems, digital assistants, etc.), communications systems (e.g., conference call systems, video conferencing systems, speaker amplification systems, etc.), and so forth. In various embodiments, one or more computing devices 110 are located in various environments including, without limitation, indoor environments (e.g., living room, conference room, conference hall, home office, etc.), and/or outdoor environments, (e.g., patio, rooftop, garden, etc.). The computing device 110 is also able to provide audio signals (g, generated using the audio application 120) to speaker(s) 160 to generate a sound field that provides various audio effects.

The one or more processing units 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU and/or a DSP. In general, a processing unit 112 can be any technically feasible hardware unit capable of processing data and/or executing software applications.

Memory 114 can include a random-access memory (RAM) module, a flash memory unit, or any other type of memory unit or combination thereof. Processing units 112 are configured to read data from and write data to the memory 114. In various embodiments, a memory 114 includes non-volatile memory, such as optical drives, magnetic drives, flash drives, or other storage. In some embodiments, separate data stores, such as an external data stores included in a network (“cloud storage”) can supplement the memory 114. The auditory band processing application 120, auditory analysis modules 124, frequency domain processing modules 128, and reconstruction modules 132 within the one or more memories 114 can be executed by one or more processing units 112 to implement the overall functionality of the one or more computing devices 110 and, thus, to coordinate the operation of the computing system 100 as a whole.

The speakers 160 include various speakers for outputting audio to create the sound field or the various audio effects in the vicinity of the user. In some embodiments, the speakers 160 are associated with a speaker configuration stored in the memory 114. The speaker configuration indicates locations and/or orientations of the speakers 160 in a three-dimensional space and/or relative to one another and/or relative to a vehicle, a vehicle seat, a gaming chair, a location of a camera, and/or the like. The auditory band processing application 120 can retrieve or otherwise identify the speaker configuration of the speakers 160 to apply certain effects using the frequency domain processing modules 128.

The auditory band processing application 120 performs an auditory transform that decomposes the time domain represented audio input 122 into multiple overlapping complex auditory bands 126. The auditory band processing application 120 separates an audio input 122 into exponentially spaced auditory bands 126 that have exponentially spaced center frequencies, for example, using auditory analysis modules 124. The auditory band processing application 120 performs frequency domain processing on the auditory bands 126 to generate processed auditory bands 130, for example, using frequency domain processing modules 128. The auditory band processing application 120 reconstructs the processed auditory bands 130 to generate an audio output 134. The auditory band processing application 120 provides the audio output 134 to the speakers 160 to produce a sound field.

The audio input 122 includes any feasible signal or data that includes an audio component. The audio input 122 can be part of any type of audio, video, multimedia, or other data file, stream, and/or the like. In some embodiments, the computing system 100 receives the audio input 122 over a network such as a local area network or a wide area network. The network can include a public and/or private network. The computing system 100 durably and/or temporarily stores the audio input 122 in the memories 114. In some embodiments, the auditory band processing application 120 processes the audio input 122 in discrete time chunks or segments. The auditory band processing application 120 segments the audio input 122 into discrete and uniformly spaced time segments according to units of time for processing.

The auditory analysis module 124 utilizes software and/or hardware filters that separate the audio input 122 (e.g., a time segment of the audio input 122) into a set of auditory bands 126. The auditory band processing application 120 uses the auditory analysis module 124 and/or other modules to generate a set of auditory bands 126 using the audio input 122. In a set of auditory bands 126, the number of auditory bands 126 grows logarithmically with increasing frequency, such that as frequency increases, fewer auditory bands 126 are present because the spacing between the bands increases (e.g., exponentially). The spacing of the set of auditory bands 126 enables the entire relevant spectrum for the audio input 122 to be represented with a lesser number of bands than prior technologies, while maintaining at least a same perceptible quality.

In one example, the auditory analysis module 124 effectively convolutes the audio input 122 with the basis function shown in equation (1) to obtain the transform for the corresponding auditory band 126.

$${h}_{k} ( n ) = {e}^{( - {β}_{k} + j 2 {f}_{k} ) π {T}_{s}} u ( n ) \qquad ( 1 )$$

$$k \to denotes the band corresponding to “ n ”$$

$${β}_{k} \to Width of kth Band$$

$${f}_{k} \to Center of kth Band$$

$${T}_{s} \to Sampling period$$

Each auditory band 126 in a set of auditory bands 126 includes a center frequency fₖ and a bandwidth βₖ that are defined, for example, by auditory band processing application 120 and/or data stored in the memories 114. The basis function shown in equation (1) includes an exponential function. The design of the set of auditory bands 126 follows the auditory characteristics of human hearing. The center frequencies and bandwidths are determined based on heuristics such that the number of auditory bands 126 grows (e.g., logarithmically) with increasing frequency, the spacing between auditory bands 126 increases (e.g., exponentially) with increasing frequency, and the bandwidth of each auditory band grows (e.g., exponentially) with increasing frequency. In some embodiments, auditory bands 126 in a set of auditory bands 126 overlap, such that each auditory band 126 includes at least a subset of the frequencies of the sequentially adjacent auditory bands 126 of the set. For example, auditory band 126 “n” of the set includes at least a subset of the frequencies of the preceding auditory band 126 “n−1” and at least a subset of the frequencies of the next auditory band 126 “n+1” of the set.

The auditory analysis module 124 decomposes a composite signal such as the audio input 122 into associated components using hardware components and/or software modules that operate as a bank of bandpass filters, where each filter within the bank is tuned to a frequency band corresponding to a center frequency fₖ and a bandwidth βₖ. When presented with an audio input 122, each auditory analysis filter passes only the frequencies within its passband and attenuates all other frequencies. In some examples, a stage gain is adjusted to be uniform across all the bands. However, in other examples the stage gain varies to provide a desired effect for a sound field. The auditory analysis module 124 is designed such that the sum of the outputs of all the filters is approximately equal to the audio input 122 for the sampling period. In some examples, the filter bank is designed and tuned in software and/or hardware based on a characteristic frequency ω and bandwidth of each filter. The characteristic frequency ω of the filter determines the center frequency fₖ for the corresponding auditory band 126. The filter bandwidth determines the width of the passband corresponding to center frequency fₖ and a bandwidth βₖ for the auditory band 126. In some examples, each auditory band 126 is down sampled to a different sampling rate identified based on the center frequency fₖ and bandwidth βₖ and/or auditory characteristics of human hearing.

A frequency domain processing module 128 performs frequency domain processing on the auditory bands 126 to generate processed auditory bands 130. The frequency domain processing module 128 uses the set of auditory bands 126 generated from the audio input 122 for processing. In some embodiments, individual auditory bands 126 are processed independently, for example, using separate frequency domain processing functions of the frequency domain processing module 128. In some embodiments, magnitudes and phases of the individual auditory bands 126 are modified by a multiplication of a complex gain, for example, corresponding to a frequency domain processing function. In some embodiments, equalization and other effects are performed by applying complex gains to each auditory band 126. These complex gains are determined by inverting the effects to be created in a calibrated environment for the sound field. In some embodiments, multiple different effects of processing are computed and final set of gains are obtained by combination of individual gains for each processing stage.

In some embodiments, the auditory band processing application 120 performs a calibration process for the frequency domain processing module 128. The calibration process computes coefficients for the auditory domain based on a set of known or preconfigured frequency domain gains for a Fourier-based frequency domain with evenly distributed and same-width frequency bands, for example, corresponding to a discrete Fourier transform. By contrast, the auditory domain corresponds to a domain for a discrete auditory transform performed using the auditory band processing application 120, where the spacing between auditory bands 126 increases (g, exponentially) with increasing frequency, and the bandwidth of each auditory band 126 grows (e.g., exponentially) with increasing frequency. For a system that is calibrated and the gains are available for a Fourier-based frequency domain, the auditory band processing application 120 determines the coefficients the auditory domain by calculating the gains for each of the auditory bands 126 from known frequency domain values. The auditory band processing application 120 performs a gain estimation process that is stabilized in an iterative procedure that measures audio output 134 and provides it as feedback. Based on the feedback, the auditory band processing application 120 modifies the coefficients and/or gains for the auditory transform process to achieve the same effects in the audio output 134 as achieved using a Fourier-based system. The auditory band processing application 120 performs the calibration process using predefined or preconfigured set of test signals such as a testing or training set of audio inputs 122 and audio outputs 134.

A reconstruction module 132 reconstructs the processed auditory bands to generate an audio output 134. The decomposition that generates the auditory band 126 introduces decomposition parameters including a gain, a processing delay, and phase shift in the auditory band 126. These parameters of each decomposition stage for each auditory band 126 are measured as a part of the design of the auditory analysis module 124 and the corresponding filters, and are stored in the memory 114 for use by the reconstruction module 132. The reconstruction module 132 resamples the processed auditory bands 130 back to the original input sampling rate of the audio input 122. The reconstruction module 132 provides compensatory gain, delay, and phase changes based on the reconstruction parameters that are generated to compensate for the measured decomposition parameters. The reconstruction module 132 adds or otherwise combines the compensated processed auditory bands 130 to obtain a composite signal such as the audio output 134. In some embodiments, the reconstruction module 132 provides compensatory gain, delay, and/or phase changes to provide a flat response relative to the decomposition effects of the auditory analysis module 124.

In one example of operation, the computing system 100 performs auditory analysis using the auditory band processing application 120. The auditory band processing application 120 performs a process based on a discrete auditory transform. For example, the auditory band processing application 120 identifies an audio input 122, for example, for a particular time period. The auditory band processing application 120 decomposes the audio input 122 into multiple complex auditory bands 126 that follow the characteristics of human perceptual system, and processes these auditory bands 126 to apply one or more effects. The auditory band processing application 120 processes the auditory bands 126 using one or more frequency domain processing modules 128. The frequency domain processing modules 128 bring in audio equalization and tuning for addressing artifacts introduced in the audio listening environment. In the same stage, the frequency domain processing modules 128 apply post processing effects such as removing undesired content or artifacts, loss compensation, mixing different signals, adding effects to create an audio atmosphere, and so on. The auditory band processing application 120 reconstructs processed auditory bands 130 using one or more reconstruction modules 132 to convert the audio data into an audio output 134. The auditory band processing application 120 provides the audio output 134 to the speakers 160 to generate or produce a sound field. The process continues for a next time period of the audio input 122. In some embodiments, the auditory band processing application 120 processes the audio input 122 based on time periods that are evenly spaced in time.

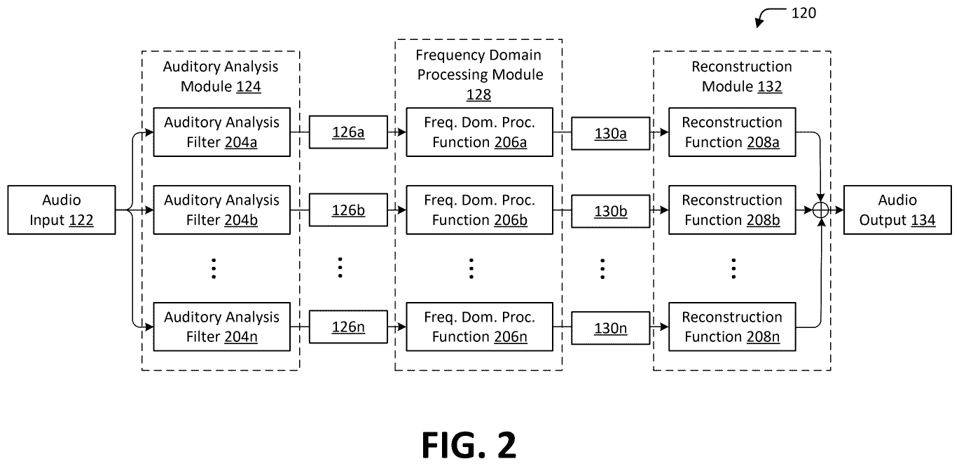

FIG. 2 is a diagram illustrating the auditory band processing application 120 of FIG. 1, according to various embodiments. As shown, auditory band processing application 120 includes and/or utilizes, without limitation, an auditory analysis module 124, a frequency domain processing module 128, and a reconstruction module 132. The auditory analysis module 124 includes, without limitation, a set of auditory analysis filters 204a, 204b . . . 204n (auditory analysis filters 204), which generate a set of auditory bands 126a, 126b . . . 126n (auditory bands 126) based on the audio input 122. The frequency domain processing module 128 includes, without limitation, a set of frequency domain processing functions 206a, 206b . . . 206n (frequency domain processing functions 206), which generate a set of processed auditory bands 130a, 130b . . . 130n (processed auditory bands 130) based on the set of auditory bands 126. The reconstruction module 132 includes, without limitation, a set of reconstruction functions 208a, 208b . . . 208n (reconstruction functions 208), which generate the audio output 134 based on the set of processed auditory bands 130.

The auditory analysis filters 204 separate the audio input 122 into the set of auditory bands 126. Each of the auditory analysis filters 204 processes the audio input 122 in relation to a corresponding auditory band 126. Each of the auditory analysis filters 204 includes a passband corresponding to an auditory band 126. For example, auditory analysis filter 204a includes a first center frequency and a first bandwidth corresponding to auditory band 126a. Auditory analysis filter 204b includes a second center frequency and a second bandwidth corresponding to auditory band 126b, and so on. The spacing between the auditory analysis filters 204 increases exponentially with increasing frequency, such that a number of auditory analysis filters 204 at higher frequencies increases logarithmically with increasing frequency. The auditory analysis filters 204 and/or the frequency domain processing functions 206 can cause auditory band specific decomposition properties or effects. The auditory band processing application 120 stores band-specific decomposition parameters for gain, delay, and phase change properties caused by decomposition of the audio input 122. The auditory band processing application 120 determines band-specific compensatory properties such as compensatory gain, delay, and phase changes to compensate for the decomposition properties. The auditory band processing application 120 stores band-specific decomposition parameters for reference by the reconstruction functions 208 and/or the reconstruction module 132.

The frequency domain processing functions 206 process the set of auditory bands 126 to generate a set of processed auditory bands 130. Each of the frequency domain processing functions 206 processes a particular auditory band 126. Each of the frequency domain processing functions 206 applies one or more frequency-specific audio effects to a corresponding auditory band 126. For example, frequency domain processing function 206a applies a first one or more frequency-specific audio effects to auditory band 126a, frequency domain processing function 206b applies a second one or more frequency-specific audio effects to auditory band 126b, and so on. The first one or more frequency-specific audio effects and the second one or more frequency-specific audio effects are applied separately by the frequency domain processing functions 206a and 206b. However, in various embodiments, the first one or more frequency-specific audio effects and the second one or more frequency-specific audio effects correspond to a single audio effect applied by the frequency domain processing module 128, or multiple different audio effects applied by the frequency domain processing module 128. As a result, the audio output 134, once reconstructed, includes one or more different audio effects.

The reconstruction functions 208 reconstruct the set of processed auditory bands 130 to generate the audio output 134. In some embodiments, each of the reconstruction functions 208 processes a particular processed auditory band 130. Each of the frequency domain processing functions 206 applies one or more band-specific compensatory properties such as compensatory gain, delay, and phase changes to compensate for the decomposition parameters. The reconstruction module 132 provides compensatory gain, delay, and phase changes based on the reconstruction parameters that are generated to compensate for the measured decomposition parameters. Each of the frequency domain processing functions 206 identifies band-specific compensatory parameters and applies band-specific compensatory properties to compensate for the to compensate for the measured decomposition parameters. The reconstruction module 132 adds or otherwise combines the compensated processed auditory bands 130 to obtain a composite signal such as the audio output 134.

In some embodiments the auditory band processing application 120 includes a set of audio processing pipelines for processing the audio input 122 to generate an audio output 134 that includes one or more audio effects. Each audio processing pipeline processes the audio input 122 in relation to a corresponding auditory band 126. Each audio processing pipeline includes, without limitation, an auditory analysis filter 204, a frequency domain processing function 206, and a reconstruction function 208. For example, a first audio processing pipeline includes the auditory analysis filter 204a, the frequency domain processing function 206a, and the reconstruction function 208a. A second audio processing pipeline includes the auditory analysis filter 204b, the frequency domain processing function 206b, and the reconstruction function 208b, and so on. Each processing pipeline enables real-time (e.g., less than 300 milliseconds) or near-real-time (e.g., less than 1 second) deconstruction of the audio input 122 and reconstruction of the audio output 134.

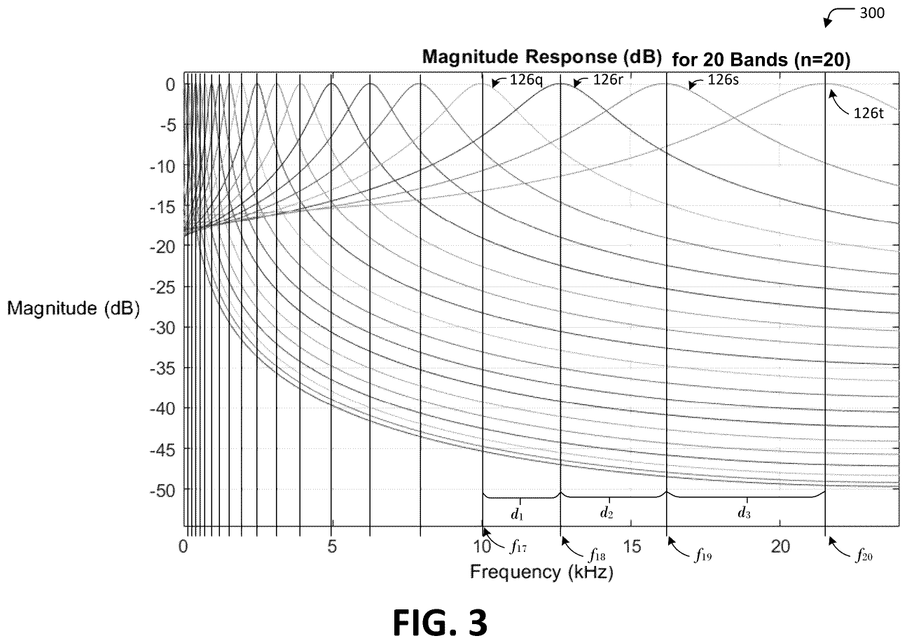

FIG. 3 is a diagram illustrating a magnitude response graph 300 that includes twenty auditory bands 126, according to various embodiments. The magnitude response graph 300 shows, without limitation, a set of twenty auditory bands 126. The set of twenty auditory bands 126 includes, without limitation, auditory bands 126q, 126r, 126s, 126t, as well as other auditory bands that are shown unlabeled for the purpose of clarity.

Auditory band 126q corresponds to center frequency f₁₇. Auditory band 126r corresponds to center frequency f₁₈. Auditory band 126s corresponds to center frequency f₁₉. Auditory band 126t corresponds to center frequency f₂₀. A frequency spacing or difference between center frequency f₁₇ and center frequency f₁₈ is shown as d₁. A frequency spacing or difference between center frequency f₁₈ and center frequency fig is shown as d₂. A frequency spacing or difference between center frequency fig and center frequency f₂₀ is shown as d₃. Other frequency spacings are not labeled for the purpose of clarity.

As can be seen, the frequency spacings between center frequencies of the auditory bands 126 become larger and larger as frequency increases, such that distance d₂ is greater than distance d₁, and distance d₃ is greater than distance d₂. The frequency spacing between center frequencies of the auditory bands 126 increases exponentially with increasing frequency over a sequence of the auditory bands 126, such that the distances d₁, d₂, and d₃ (and other frequency spacings of the twenty auditory bands 126) grow as an exponential function of frequency. As a result, the number of auditory bands 126 in a span of a particular frequency size grows logarithmically, such that the number auditory bands 126 in a span of a particular frequency size becomes smaller and smaller at higher frequencies.

As can be seen, the bandwidths of auditory bands 126 become larger and larger as frequency increases such that a bandwidth of auditory band 126r is greater than a bandwidth of auditory band 126q, a bandwidth of auditory band 126s is greater than a bandwidth of auditory band 126r, and a bandwidth of auditory band 126t is greater than a bandwidth of auditory band 126t. In some examples, the bandwidths auditory bands 126 increase as an exponential function of frequency. Auditory band processing application 120 sets the center frequency and bandwidths for each of the auditory bands 126, for example, based on one or more exponential functions.

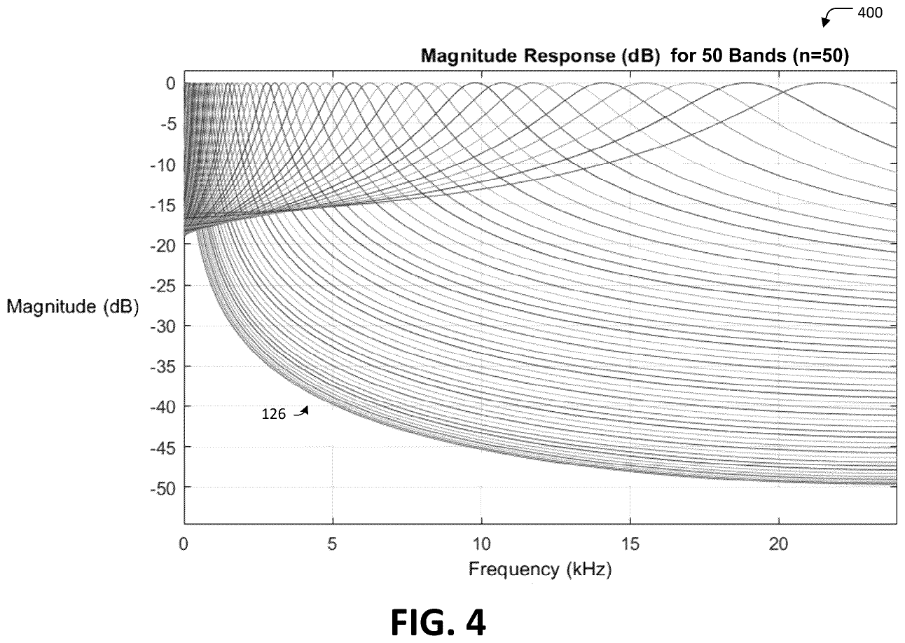

FIG. 4 is a diagram illustrating a magnitude response graph 400 that includes fifty auditory bands 126, according to various embodiments. The magnitude response graph 400 shows, without limitation, a set of fifty auditory bands 126. As can be seen, the frequency spacings between center frequencies of the auditory bands 126 become larger and larger as frequency increases. For example, the frequency spacing between center frequencies of the auditory bands 126 increases exponentially with increasing frequency over a sequence of the auditory bands 126. As a result, the number of auditory bands 126 in a span of a particular frequency size grows logarithmically, such that the number auditory bands 126 in a span of a particular frequency size becomes smaller and smaller at higher frequencies. As can be seen, the bandwidths of auditory bands 126 become larger and larger as frequency increases. In some examples, the bandwidths auditory bands 126 increase as an exponential function of frequency. Auditory band processing application 120 sets the center frequency and bandwidths for each of the auditory bands 126, for example, based on one or more exponential functions.

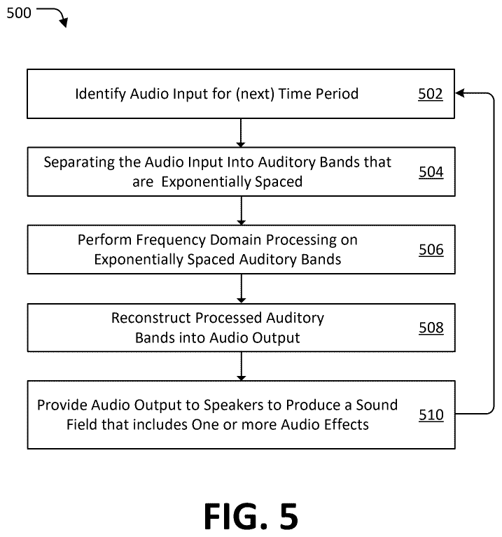

FIG. 5 is a flow diagram of method steps for generating a sound field using an auditory band processing application 120, according to various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1 and 2 and the examples of FIGS. 3 and 4, persons skilled in the art will understand that any system configured to perform the method steps, in any order, falls within the scope of the various embodiments.

As shown, a method 500 begins at step 502, where the auditory band processing application 120 identifies an audio input 122 for a particular time period. In some embodiments, the auditory band processing application 120 receives the audio input 122 over a network and/or retrieves the audio input 122 from one or more memories 114. The computing system 100 durably and/or temporarily stores the audio input 122 in the memories 114. The audio input 122 can include part of any type of audio, video, multimedia, or other data file, stream, and/or the like.

At step 504, the auditory band processing application 120 separates the audio input 122 for that time period into auditory bands 126 that are exponentially spaced. The auditory band processing application 120 utilizes software and/or hardware filters that separate the audio input 122 into a set of auditory bands 126. In some embodiments, the auditory band processing application 120 includes an auditory analysis module that includes a set of auditory analysis filters 204 that separates the audio input 122 into the set of auditory bands 126, such that each auditory analysis filter 204 generates a single auditory band 126. The auditory band processing application 120 uses the auditory analysis module 124 and/or other modules to generate a set of auditory bands 126 using the audio input 122. In a set of auditory bands 126, the number of auditory bands 126 grows logarithmically and the frequency spacing between the bands increases exponentially. The spacing of the set of auditory bands 126 enables the entire relevant spectrum for the audio input 122 to be represented with a lesser number of bands than prior technologies, while maintaining at least a same perceptible quality.

At step 506, the auditory band processing application 120 performs frequency domain processing on the auditory bands 126 to apply one or more audio effects. The auditory band processing application 120 processes the set of auditory bands 126 to generate a set of processed auditory bands 130. In some embodiments, the auditory band processing application 120 includes a frequency domain processing module 128 that includes a set of frequency domain processing functions 206 that processes the set of auditory bands 126, such that each frequency domain processing function 206 processes a single auditory band 126. In some embodiments, the auditory band processing application 120 applies audio equalization and tuning based on the audio listening environment, while also applying post processing effects.

At step 508, the auditory band processing application 120 reconstructs processed auditory bands 130 using one or more reconstruction modules 132 to convert the audio data into an audio output 134. The auditory band processing application 120 reconstruct the set of processed auditory bands 130 to generate the audio output 134. Decomposition of the audio input 122 in steps 504 and/or 506 introduces decomposition properties or effects. The auditory band processing application 120 identifies and stores band-specific decomposition parameters for gain, delay, and phase change properties caused by decomposition of the audio input 122. The auditory band processing application 120 determines compensatory properties such as compensatory gain, delay, and phase changes to compensate for the decomposition properties. The auditory band processing application 120 stores decomposition parameters for reference by the reconstruction functions 208 and/or the reconstruction module 132. The auditory band processing application 120 identifies compensatory parameters and applies compensatory properties to compensate for the to compensate for the decomposition parameters. The reconstruction module 132 also adds or otherwise combines the compensated processed auditory bands 130 to obtain a composite signal such as the audio output 134.

At step 510, the auditory band processing application 120 provides the audio output 134 to the speakers 160. As a result, the speakers 160 generate or produce a sound field of the audio output 134. The sound field includes the one or more audio effects. The overall method 500 moves to step 502 and continues for a next time period of the audio input 122. In some embodiments the auditory band processing application 120 processes multiple time periods of the audio input 122 with at least partial concurrence to provide a continuous audio output.

In sum, techniques are disclosed for audio processing, and more specifically, to audio processing using auditory analysis based on discrete auditory transforms that decompose an audio input into multiple complex auditory bands that follow the characteristics of the human perceptual system, and processes these auditory bands 126 to apply one or more effects, for example, according to exponentially spaced auditory bands. One embodiment of the present disclosure sets forth a method that separates an audio input into exponentially spaced auditory bands that include exponentially spaced center frequencies, performing frequency domain processing on the exponentially spaced auditory bands to generate processed auditory bands, and reconstructing the processed auditory bands to generate an audio output and produce a sound field. Further embodiments include systems and non-transitory computer-readable media that perform the steps of the method.

The disclosed techniques provide more effective analysis of the input signal in terms of how the human listening system perceives the resulting audio signal. As a result, the processing has greater effect on the listening and giving better handle for implementing the effects of processing with optimal number of bands and hence the processing. The disclosed techniques provide greater efficiency in processing audio signals while retaining human-discernable audio quality. The disclosed techniques reduce hardware resource usage. The disclosed techniques are also capable of increasing audio quality relative to prior approaches, for example, when using similar hardware resource usage as prior approaches. In some cases, the disclosed techniques enable both greater efficiency in processing audio signals and increased human-discernable audio quality. These technical advantages represent one or more technological improvements over prior art approaches.

1. In some embodiments, a computer-implemented method comprises separating an audio input into exponentially spaced auditory bands comprises exponentially spaced center frequencies, performing frequency domain processing on the exponentially spaced auditory bands to generate processed auditory bands, and reconstructing the processed auditory bands to generate an audio output to produce a sound field.

2. The computer-implemented method of clause 1, further comprising receiving or identifying the audio input for a particular time period.

3. The computer-implemented method of clauses 1 or 2, further comprising providing the audio output to a speaker to produce the sound field.

4. The computer-implemented method of any of clauses 1-3, wherein the frequency domain processing is performed to apply one or more effects, and the sound field includes the one or more effects.

5. The computer-implemented method of any of clauses 1-4, wherein a frequency spacing between adjacent ones of the exponentially spaced auditory bands increases exponentially as frequency increases.

6. The computer-implemented method of any of clauses 1-5, wherein a bandwidth of adjacent ones of the exponentially spaced auditory bands increases exponentially as frequency increases.

7. The computer-implemented method of any of clauses 1-6, wherein adjacent ones of the exponentially spaced auditory bands include one or more overlapping frequencies.

8. The computer-implemented method of any of clauses 1-7, wherein the exponentially spaced auditory bands comprise bandwidths based on a fifty percent overlap between adjacent ones of the exponentially spaced auditory bands.

9. The computer-implemented method of any of clauses 1-8, wherein reconstructing the processed auditory bands comprises resampling the processed auditory bands into an original input sampling rate of the audio input.

10. The computer-implemented method of any of clauses 1-9, wherein reconstructing the processed auditory bands comprises identifying, for each of the exponentially spaced auditory bands, decomposition parameters associated with decomposing the audio input, the decomposition parameters comprising a gain, a processing delay, and phase shift, and applying, to each of the processed auditory bands, a compensatory gain, compensatory delay, and compensatory phase change to correct for the decomposition parameters.

11. The computer-implemented method of any of clauses 1-10, wherein separating the audio input is performed using a plurality of filters corresponding to the exponentially spaced auditory bands.

12. In some embodiments, one or more non-transitory computer-readable media store instructions that, when executed by one or more processors, cause the one or more processors to perform the steps of generating auditory bands based on an audio input, the auditory bands comprising exponentially spaced center frequencies, performing frequency domain processing on the auditory bands to generate processed auditory bands, and producing an audio output by reconstructing the processed auditory bands.

13. The computer-implemented method of clause 12, wherein the frequency domain processing is performed to apply one or more effects, and the audio output includes the one or more effects.

14. The computer-implemented method of clauses 12 or 13, wherein a frequency spacing between adjacent ones of the auditory bands increases exponentially as frequency increases.

15. The one or more non-transitory computer-readable media of any of clauses 12-14, wherein a bandwidth of adjacent ones of the auditory bands increases exponentially as frequency increases.

16. The one or more non-transitory computer-readable media of any of clauses 12-15, wherein adjacent ones of the auditory bands include one or more overlapping frequencies.

17. The one or more non-transitory computer-readable media of any of clauses 12-16, wherein the auditory bands comprise bandwidths based on a fifty percent overlap between adjacent ones of the auditory bands.

18. The one or more non-transitory computer-readable media of any of clauses 12-17, wherein reconstructing the processed auditory bands comprises resampling the processed auditory bands into an original input sampling rate of the audio input.

19. The one or more non-transitory computer-readable media of any of clauses 12-18, wherein reconstructing the processed auditory bands comprises identifying, for each of the auditory bands, decomposition parameters associated with decomposing the audio input, the decomposition parameters comprising a gain, a processing delay, and phase shift, and applying, to each of the processed auditory bands, a compensatory gain, compensatory delay, and compensatory phase change to correct for the decomposition parameters.

20. In some embodiments, a system comprises one or more speakers, a memory storing instructions, and one or more processors, that when executing the instructions, are configured to perform the steps of separating an audio input into auditory bands comprises exponentially spaced center frequencies, performing frequency domain processing on the auditory bands to generate processed auditory bands, and generating an audio output by reconstructing the processed auditory bands.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
separating an audio input into exponentially spaced auditory bands comprising exponentially spaced center frequencies;
performing frequency domain processing on the exponentially spaced auditory bands to generate processed auditory bands; and
reconstructing the processed auditory bands to generate an audio output to produce a sound field.

2. The computer-implemented method of claim 1, further comprising:
receiving or identifying the audio input for a particular time period.

3. The computer-implemented method of claim 1, further comprising:
providing the audio output to a speaker to produce the sound field.

4. The computer-implemented method of claim 1, wherein the frequency domain processing is performed to apply one or more effects, and the sound field includes the one or more effects.

5. The computer-implemented method of claim 1, wherein a frequency spacing between adjacent ones of the exponentially spaced auditory bands increases exponentially as frequency increases.

6. The computer-implemented method of claim 1, wherein a bandwidth of adjacent ones of the exponentially spaced auditory bands increases exponentially as frequency increases.

7. The computer-implemented method of claim 1, wherein adjacent ones of the exponentially spaced auditory bands include one or more overlapping frequencies.

8. The computer-implemented method of claim 1, wherein the exponentially spaced auditory bands comprise bandwidths based on a fifty percent overlap between adjacent ones of the exponentially spaced auditory bands.

9. The computer-implemented method of claim 1, wherein reconstructing the processed auditory bands comprises:
resampling the processed auditory bands into an original input sampling rate of the audio input.

10. The computer-implemented method of claim 1, wherein reconstructing the processed auditory bands comprises:
identifying, for each of the exponentially spaced auditory bands, decomposition parameters associated with decomposing the audio input, the decomposition parameters comprising a gain, a processing delay, and phase shift; and
applying, to each of the processed auditory bands, a compensatory gain, compensatory delay, and compensatory phase change to correct for the decomposition parameters.

11. The computer-implemented method of claim 1, wherein separating the audio input is performed using a plurality of filters corresponding to the exponentially spaced auditory bands.

12. One or more non-transitory computer-readable media storing instructions that, when executed by one or more processors, cause the one or more processors to perform the steps of:
generating auditory bands based on an audio input, the auditory bands comprising exponentially spaced center frequencies;
performing frequency domain processing on the auditory bands to generate processed auditory bands; and
producing an audio output by reconstructing the processed auditory bands.

13. The computer-implemented method of claim 1, wherein the frequency domain processing is performed to apply one or more effects, and the audio output includes the one or more effects.

14. The computer-implemented method of claim 1, wherein a frequency spacing between adjacent ones of the auditory bands increases exponentially as frequency increases.

15. The one or more non-transitory computer-readable media of claim 12, wherein a bandwidth of adjacent ones of the auditory bands increases exponentially as frequency increases.

16. The one or more non-transitory computer-readable media of claim 12, wherein adjacent ones of the auditory bands include one or more overlapping frequencies.

17. The one or more non-transitory computer-readable media of claim 12, wherein the auditory bands comprise bandwidths based on a fifty percent overlap between adjacent ones of the auditory bands.

18. The one or more non-transitory computer-readable media of claim 12, wherein reconstructing the processed auditory bands comprises:
resampling the processed auditory bands into an original input sampling rate of the audio input.

19. The one or more non-transitory computer-readable media of claim 12, wherein reconstructing the processed auditory bands comprises:
identifying, for each of the auditory bands, decomposition parameters associated with decomposing the audio input, the decomposition parameters comprising a gain, a processing delay, and phase shift; and
applying, to each of the processed auditory bands, a compensatory gain, compensatory delay, and compensatory phase change to correct for the decomposition parameters.

20. A system comprising:
one or more speakers;
a memory storing instructions; and
one or more processors, that when executing the instructions, are configured to perform the steps of:
separating an audio input into auditory bands comprising exponentially spaced center frequencies;
performing frequency domain processing on the auditory bands to generate processed auditory bands; and
generating an audio output by reconstructing the processed auditory bands.
